(19) United States
(12) Patent Application Publication
(10) Pub. No.: US 2011/0033075 A1
(43) Pub. Date: Feb. 10, 2011

(54) PRENATAL INTERACTIVE TOOLBOX

(76) Inventor: Gordon Joseph VIRTUE, Rosedale (CA)

Correspondence Address: IRENE M. WALLER LAW CORPORATION, 5380 WILLIAMS ROAD, RICHMOND, BC, V7E 1K1, CA

(21) Appl. No.: 12/538,144

(22) Filed: Aug. 9, 2009

(51) Int. Cl. H04R 9/06

(52) U.S. Cl. 381/336

(57) ABSTRACT

A prenatal interactive toolbox has a flexible and adjustable belt having an adjustable fastening means and having a centrally located support panel with an anchor means. A removable mat configured as a pouch having an anchor mate means dimensioned and configured to removably mate with the anchor means of the support panel whereby the mat is held snugly and comfortably against the abdominal wall of a pregnant woman. The mat houses at least one pressure activated sound generating means. The at least one pressure activated sound generating means is set to be activated by the motion of a fetus in the womb of a pregnant woman wearing the prenatal interactive toolbox.

### FIELD OF THE INVENTION

This invention relates generally to an apparatus for interacting with a fetus and more particularly to a prenatal interactive toolbox.

### BACKGROUND OF THE INVENTION

It has been shown from ultrasound observations that a fetus hears and responds to sound starting at about 16 weeks of age. The connection between sound and music and prenatal memory and learning is an ongoing research area (Whitwell, G. E., RMT. (1999). “The importance of prenatal sound and music”, Journal of Prenatal and Perinatal Psychology and Health, 13 (3-4), 255-262). Studies have indicated that babies who have been stimulated while in the womb exhibit advanced visual, auditory, language and motor development skills.

Many systems have been designed that place sound generating devices adjacent to a pregnant mother's abdomen so that sound may be transmitted through the womb to the fetus.

U.S. Pat. No. 4,768,612 (Hodson, 6 Sep. 1988) discloses a device having a hollow speaking tube having a mouth piece connected to one end thereof and having a funnel shaped portion connected to the other end thereof. The funnel shaped portion is designed to be placed on the abdomen of a pregnant woman thereby allowing the woman or others use the mouth piece to speak to the unborn fetus.

U.S. Pat. No. 6,169,814 (Johnson, 2 Jan. 2001) discloses a microphone that is electrically connected to an amplifier which is in turn connected to speakers. The amplifier and speakers are contained in a housing which is designed for resting against the belly of a pregnant woman.

U.S. Pat. No. 6,718,044 (Alleyne, 2 Apr. 2004) discloses a wireless microphone for transmitting audio signals to a fetus.

United States Patent Application Publication No. 2009/0161892 (Servello et al., 25 Jun. 2009) discloses an acoustic driver designed for allowing the more efficient transmission of sound into the body of a pregnant woman.

While various prior designs have some degree of isolated merit, none fully meets all the objective of stimulating interaction of the fetus by allowing the fetus to actively participate in the production of the transmitted sound.

### SUMMARY OF THE INVENTION

An objective of the present invention is to provide a device for allowing direct interaction with a fetus, in particular, a prenatal interactive toolbox is provided whereby the motion of the fetus in the womb of a pregnant woman is sufficient to activate the generation of sound.

The present invention provides an apparatus for stimulating the movement of an unborn child by exposing an unborn child to audio stimulation, the audio stimulation being triggered by the movement of the unborn child.

In one aspect of the present invention there is provided a prenatal interactive toolbox comprising: a) a flexible and adjustable belt having an adjustable fastening means and having a centrally located support panel, the support panel fitted with at least one anchor secured thereto; b) a removable mat configured as a pouch having at least one anchor mate secured thereto, the anchor mate dimensioned and configured to removably mate with the at least one anchor on the support panel whereby the mat is held snugly and comfortably against the abdominal wall of a pregnant woman; c) the mat having at least one pressure activated sound generating means secured within the pouch of the mat; and wherein the at least one pressure activated sound generating means is set to be activated by the motion of a fetus in the womb of a pregnant woman wearing the prenatal interactive toolbox.

An advantage of the present invention is that this invention allows the fetus to actively participate in the control of the generation of sound.

### BRIEF DESCRIPTION OF THE DRAWINGS

The present invention will be further understood from the following description with reference to the accompanying drawings of a representative prenatal interactive toolbox according to an embodiment of the invention, in which all views are schematic and may not be to scale.

FIG. 1, in a partially exploded view, illustrates an embodiment of the prenatal interactive tool box of the present invention.

FIG. 2, in an exploded view, illustrates the removable mat of the prenatal interactive tool box of FIG. 1.

In the drawings, preferred embodiments of the prenatal interactive toolbox according to the invention are illustrated by way of example. It is to be expressly understood that the description and drawings are only for the purpose of illustration and as an aid to understanding, and are not intended to be a constraint on the limits of the invention.

### DETAILED DESCRIPTION

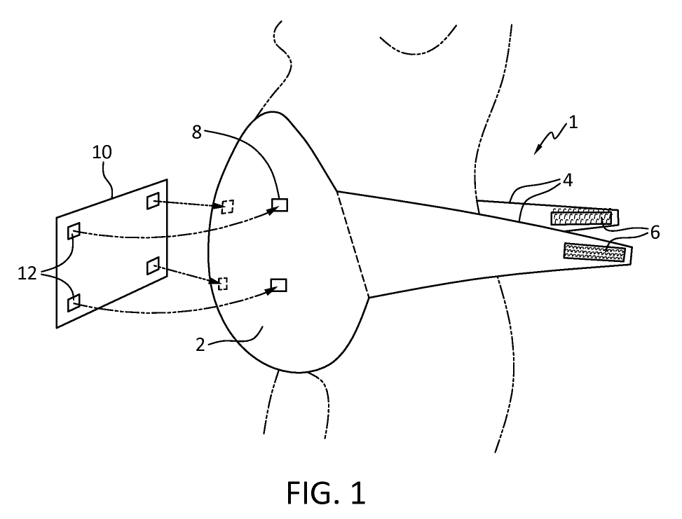

Referring to FIG. 1, a prenatal interactive toolbox 1 includes a central support panel 2 having a pair of elongate straps 4 connected on either side of the central support panel 2. The straps 4 preferably are made of a material having elastic properties. The straps 4 are provided on their distal ends with an adjustable fastening means 6 designed and configured to allow the pair of straps 4 to be fastened together. The adjustable fastening means 6 may be any adjustable fastening means known in the art such as Velcro™, hooks, snaps, buckles, etc. The adjustable fastening means 6 allows the wearer to customize the fit of the prenatal interactive toolbox 1 to the wearer's individual waist size.

The central support panel 2 has at least one anchor 8 attached to the face of the central support panel 2. The at least one anchor 8 may be any attachment means known in the art such as Velcro™, hooks, snaps, buckles, etc.

The prenatal interactive toolbox 1 is provided with a removable mat 10 which has at least one anchor mate 12 secured on one side thereof, the at least one anchor mate 12 designed and configured to mate with the at least one anchor 8 attached to the face of the central support panel 2. When the mat 10 is attached to the central support panel 2, the mat 10 is held snugly and comfortably against the abdominal wall of a pregnant woman wearing the prenatal interactive toolbox 1.

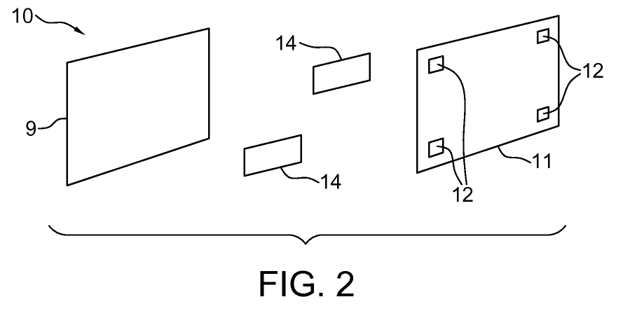

Referring to FIG. 2, the mat 10 is designed and configured as a hollow pouch having a front wall 9 and a rear wall 11 made of non-rigid material. The mat 10 may be sealed or, alternatively, the mat 10 may have an opening which is closable by a zipper, snap fastener, and the like, etc. Within the mat 10 there is secured at least one pressure actuated sound generating means 14. The at least one pressure actuated sound generating means 14 may be any one of commercially available sound generating means configurable by the manufacturer to produce sound patterns simulating crying, laughing, animal vocalizations, human vocalizations and music. The sound generating means 14 preferably is activated by applying pressure to the sound generating means 14. The at least one sound generating means 14 may be activated by a person applying pressure to sound generating means 14. Alternatively, the sound generating means 14 may be activated by the movement of a fetus within the womb of the person wearing the prenatal interactive toolbox 1 and thus triggering the production of sound from the at least one pressure activated sound generating means 14. Examples of the at least one pressure activated sound generating means 14 include, but are not limited to Series 1301 Sound Modules from AGC Sound; Melody Module item nos. WS245M, WS209M, WS205M, WS450M, WS442M, WS363M, WS329M, WS318M, etc. from Winshing Enterprises Limited; Voice Box model no. T-92 from Shing Tat Electronics Ltd.; Musical Module model no. T-8 from Shing Tat Electronics Ltd.; model CO-R46 from Shenzhen Cover Industrial Co., Ltd.; model nos. LTP-SB5034, LTP-SB4132 from Yueqing Leapet Electric Co., Ltd. The removable mat 10 provides the wearer with the option of selecting and attaching desired sound generating means.

Other variations and modifications of the invention are possible. For example, the mat may be permanently attached to the support straps. Alternatively, the pouch on the mat may be provided with an access opening through which selected sound generating means may be inserted. Alternatively, other maternity garments such as tunics, pants, etc., may be fitted with anchor means such that the mat may be attached thereto. All such modifications or variations and others that will occur to those skilled in the design of such systems are considered to be within the scope of the invention as defined by the claims appended hereto.

1. A prenatal interactive toolbox comprising:
a) a flexible and adjustable belt having an adjustable fastening means and having a centrally located support panel, the support panel fitted with at least one anchor secured thereto;
b) a removable mat configured as a pouch having at least one anchor mate secured thereto, the anchor mate dimensioned and configured to removably mate with the at least one anchor on the support panel whereby the mat is held snugly and comfortably against the abdominal wall of a pregnant woman;
c) the mat having at least one pressure activated sound generating means secured within the pouch of the mat; and wherein
the at least one pressure activated sound generating means is set to be activated by the motion of a fetus in the womb of a pregnant woman wearing the prenatal interactive toolbox.

2. The prenatal interactive toolbox of claim 1 wherein the at least one pressure activated sound generating means generates music upon activation.

3. The prenatal interactive toolbox of claim 1 wherein the at least one pressure activated sound generating means generates animal vocalizations upon activation.

4. The prenatal interactive toolbox of claim 1 wherein the at least one pressure activated sound generating means is activated by external pressure applied thereto.

5. The prenatal interactive toolbox of claim 1 wherein the at least one pressure activated sound generating means generates vocalization of a story book upon activation.

6. A prenatal interactive toolbox mat comprising:
a) a mat configured as a pouch having at least one anchor mate secured thereto, the anchor mate dimensioned and configured to removably mate with at least one anchor on a support panel of a prenatal interactive toolbox;
b) at least one pressure activated sound generating means secured and located in the pouch of the mat; and wherein
the at least one pressure activated sound generating means is set to be activated by the motion of a fetus in the womb of a pregnant woman having the prenatal interactive toolbox mat in communication with the abdomen of the pregnant woman.

7. A system for stimulating a fetus comprising:
a maternity garment having secured therewithin a means for generating sound, said means for generating sound being triggered by pressure; and
whereby the means for generating sound is triggered by the motion of a fetus within the womb of a woman wearing the maternity garment.
